(19) United States
(12) Patent Application Publication
(10) Pub. No.: US 2022/0021004 A1
(43) Pub. Date: Jan. 20, 2022

(54) NON-AQUEOUS ELECTROLYTE SECONDARY BATTERY

(71) Applicant: TOYOTA JIDOSHA KABUSHIKI KAISHA, Toyota-shi (JP)

(72) Inventors: Akira KIYAMA, Toyota-shi (JP); Sho Ando, Seto-shi (JP); Kunimitsu Yamamoto, Kasugai-shi (JP); Masaki Kato, Zushi-shi (JP); Koshiro Yoneda, Ichinomiya-shi (JP); Kensaku Miyazawa, Toyota-shi (JP)

(73) Assignee: TOYOTA JIDOSHA KABUSHIKI KAISHA, Toyota-shi (JP)

(21) Appl. No.: 17/366,379

(22) Filed: Jul. 2, 2021

(30) Foreign Application Priority Data
Jul. 15, 2020 (JP) 2020-121156

(51) Int. Cl. H01M 4/66; H01M 10/0525; H01M 4/04; H01M 4/525; H01M 4/505; H01M 4/58; H01M 4/74; H01M 4/36; H01M 50/46

(52) U.S. Cl. CPC H01M 4/667; H01M 10/0525; H01M 4/662; H01M 4/0404; H01M 4/525; H01M 2004/028; H01M 4/58; H01M 4/742; H01M 4/366; H01M 50/46; H01M 4/505

(57) ABSTRACT

A cell, which is a non-aqueous electrolyte secondary battery, includes: an electrode assembly including a plurality of sheet-shaped positive electrodes and a plurality of sheet-shaped negative electrodes, the plurality of positive electrodes and the plurality of negative electrodes being alternately stacked with separators interposed therebetween; and a battery case that houses the electrode assembly. The electrode assembly includes: an outer layer including a positive electrode arranged on an outermost side of the electrode assembly, and a separator adjacent to the positive electrode; and an inner layer arranged on an inner side of the outer layer. The outer layer includes a fusing member configured to fuse due to heat generation in the electrode assembly caused by a short circuit in the electrode assembly. The inner layer does not include the fusing member.

This nonprovisional application is based on Japanese Patent Application No. 2020-121156 filed on Jul. 15, 2020 with the Japan Patent Office, the entire contents of which are hereby incorporated by reference.

### BACKGROUND

### Field

The present disclosure relates to a non-aqueous electrolyte secondary battery.

### Description of the Background Art

In recent years, there has been a growing demand for lithium ion secondary batteries as power sources for traveling for hybrid vehicles, plug-in hybrid vehicles, electric vehicles and the like. A typical lithium ion secondary battery mountable on a vehicle includes an electrode assembly formed by winding positive electrodes and negative electrodes stacked with separators interposed therebetween, and a battery case that houses the electrode assembly (refer to, for example, Japanese Patent Laying-Open No. 2019-186156).

### SUMMARY

In a process of manufacturing a non-aqueous electrolyte secondary battery such as a lithium ion secondary battery, a metal foreign object (foreign object having electrical conductivity) may enter a battery case. When the metal foreign object enters the battery case, an electrode assembly may be short-circuited and generate heat, which may in turn cause thermal runaway in the electrode assembly. Therefore, it is conceivable to take measures to suppress the heat generation. However, when excessive measures are taken, there may arise an undesirable effect such as a decrease in energy density of the non-aqueous electrolyte secondary battery or an increase in size of the non-aqueous electrolyte secondary battery.

The present disclosure has been made to solve the above-described problem, and an object of the present disclosure is to suppress heat generation (particularly, thermal runaway) caused by a short circuit in an electrode assembly, while preventing an undesirable effect such as a decrease in energy density or an increase in size.

(1) A non-aqueous electrolyte secondary battery according to an aspect of the present disclosure includes: an electrode assembly including a plurality of sheet-shaped positive electrodes and a plurality of sheet-shaped negative electrodes, the plurality of positive electrodes and the plurality of negative electrodes being alternately stacked with separators interposed therebetween; and a battery case that houses the electrode assembly. The electrode assembly includes: an outer layer including a positive electrode arranged on an outermost side of the electrode assembly, of the plurality of positive electrodes, and a separator adjacent to the positive electrode, of the separators; and an inner layer arranged on an inner side of the outer layer. The outer layer includes a fusing member configured to fuse due to heat generation in the electrode assembly caused by a short circuit in the electrode assembly. The inner layer does not include the fusing member.

In the configuration in (1) above, the outer layer includes the fusing member. When a metal foreign object causes a short circuit in the electrode assembly and a short circuit current flows, the fusing member fuses immediately. Then, a short circuit path (positive electrode-metal foreign object-negative electrode path) through the metal foreign object inside the electrode assembly is cut off. As a result, the short circuit current no longer flows, and thus, heat generation in the electrode assembly can be suppressed. In addition, the fusing member is locally provided in the outer layer, not throughout the electrode assembly, and thus, an undesirable effect such as a decrease in energy density or an increase in size can be prevented. Therefore, according to the configuration in (1) above, it is possible to suppress the heat generation caused by the short circuit in the electrode assembly, while preventing an undesirable effect such as a decrease in energy density or an increase in size.

(2) Each of the plurality of positive electrodes includes a positive electrode current collector and a positive electrode composite material layer. The positive electrode current collector arranged in the outer layer is thinner than the positive electrode current collector arranged in the inner layer. The fusing member includes the positive electrode current collector arranged in the outer layer.

In the configuration in (2) above, the positive electrode current collector included in the outer layer is made thinner, and thus, the positive electrode current collector is more likely to fuse or evaporate due to a short circuit in the electrode assembly. Therefore, according to the configuration in (2) above, fusing of the positive electrode current collector in a short time can be achieved.

(3) Each of the plurality of positive electrodes includes a positive electrode current collector and a positive electrode composite material layer. The positive electrode current collector arranged in the outer layer is perforated metal foil provided with a plurality of through holes. The fusing member includes the perforated metal foil.

(4) The perforated metal foil is any one of a punching metal, an expanded metal and a lath metal.

In the configuration in (3) and (4) above, the positive electrode current collector is the perforated metal foil, and thus, the positive electrode current collector is more likely to fuse or evaporate due to a short circuit in the electrode assembly. Therefore, according to the configuration in (3) and (4) above, fusing of the positive electrode current collector in a short time can be achieved.

(5) The electrode assembly is of stack type.

According to the configuration in (5) above, the non-aqueous electrolyte secondary battery can be easily manufactured.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing one example of a configuration of a lithium ion secondary battery according to a first embodiment.

FIG. 2 is a perspective view schematically showing another example of the configuration of the lithium ion secondary battery according to the first embodiment.

FIG. 3 shows one example of a configuration of an electrode assembly in the first embodiment.

FIG. 4 schematically shows a cross section of the electrode assembly taken along line IV-IV in FIG. 3.

FIG. 5 is a conceptual diagram for illustrating an effect obtained by reducing a thickness of a positive electrode current collector.

FIG. 6 schematically shows a cross section of an electrode assembly in a second embodiment.

FIG. 7 is a top view showing a structure of a positive electrode current collector in the second embodiment.

### DESCRIPTION OF THE PREFERRED EMBODIMENTS

Embodiments of the present disclosure will be described in detail hereinafter with reference to the drawings, in which the same or corresponding portions are denoted by the same reference characters and description thereof will not be repeated. In the embodiments described below, a lithium ion secondary battery is used as an exemplary form of a non-aqueous electrolyte secondary battery according to the present disclosure. However, the non-aqueous electrolyte secondary battery according to the present disclosure is not limited thereto, and may be, for example, a sodium ion secondary battery.

### First Embodiment

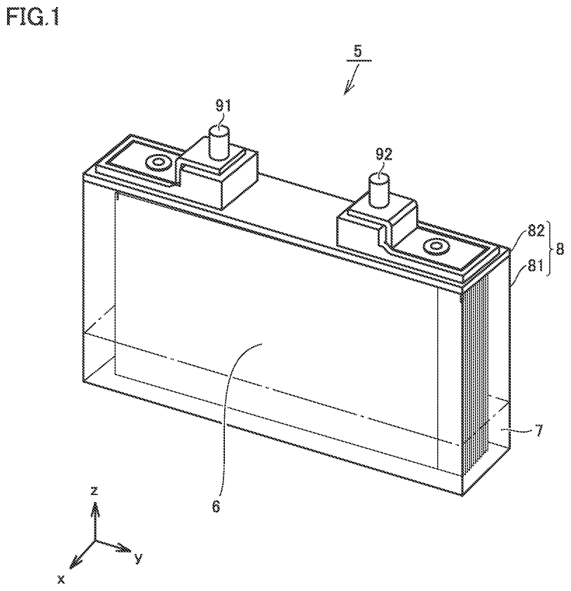

FIG. 1 is a perspective view schematically showing one example of a configuration of a lithium ion secondary battery according to a first embodiment. In the following description, the lithium ion secondary battery according to the first embodiment is denoted as a cell 5. For ease of understanding, FIG. 1 shows cell 5 in a see-through manner.

In this example, cell 5 is a sealed battery having a rectangular shape. However, the shape of cell 5 is not limited to the rectangular shape, and may be, for example, a cylindrical shape. Cell 5 includes an electrode assembly 6, an electrolyte 7 and a battery case 8.

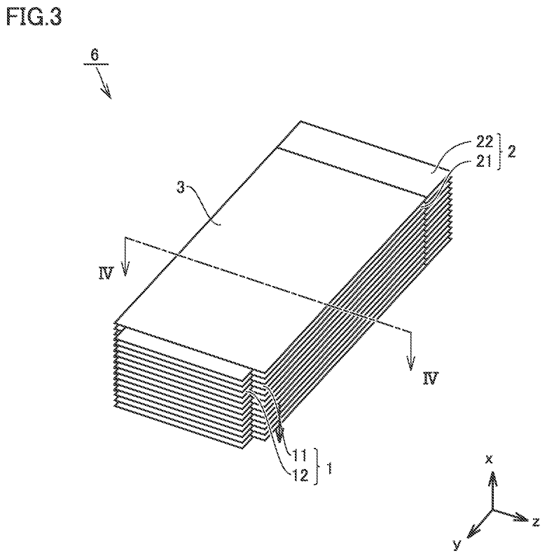

Electrode assembly 6 shown in FIG. 1 is of stack type. That is, electrode assembly 6 is formed by alternately stacking positive electrodes 1 and negative electrodes 2 with separators 3 interposed therebetween (see FIG. 3).

Electrolyte 7 is injected into battery case 8 and electrode assembly 6 is impregnated with electrolyte 7. In FIG. 1, a liquid level of electrolyte 7 is shown by an alternate long and short dash line. Detailed configurations such as materials used for electrode assembly 6 (positive electrodes 1, negative electrodes 2 and separators 3) and electrolyte 7 will be described below.

Battery case 8 may be made of, for example, an aluminum (Al) alloy and the like. However, battery case 8 may be, for example, a pouch made of an Al laminate film, as long as battery case 8 can be sealed. Battery case 8 includes a case main body 81 and a lid 82.

Case main body 81 houses electrode assembly 6 and electrolyte 7. Case main body 81 has a flat rectangular parallelepiped outer shape. Case main body 81 and lid 82 are joined by, for example, laser welding. Lid 82 is provided with a positive electrode terminal 91 and a negative electrode terminal 92. Although not shown, lid 82 may be further provided with a liquid injection port, a gas discharge valve, a current interrupt device (CID) and the like.

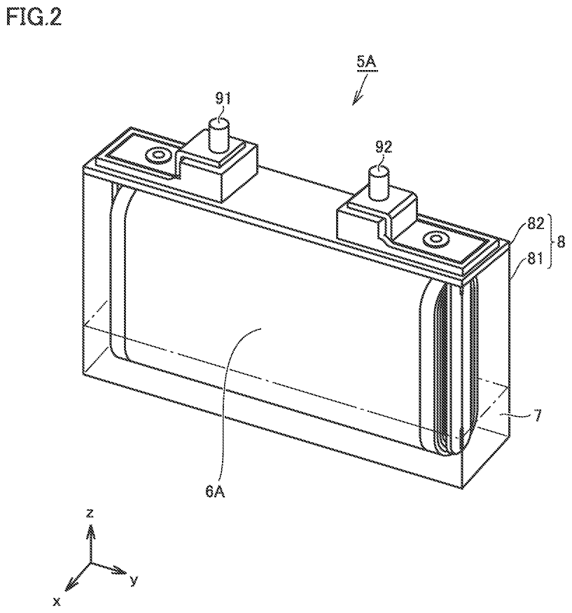

FIG. 2 is a perspective view schematically showing another example of the configuration of the lithium ion secondary battery according to the first embodiment. Referring to FIG. 2, a cell 5A is different from cell 5 shown in FIG. 1, in that cell 5A includes an electrode assembly 6A of winding type instead of electrode assembly 6 of stack type. Electrode assembly 6A of winding type is formed by alternately stacking positive electrodes 1 and negative electrodes 2 with separators 3 interposed therebetween to thereby obtain a stacked body, and cylindrically winding the stacked body.

Although electrode assembly 6 of stack type is taken as an example in the following description, a configuration similar to the configuration described below may be applied to electrode assembly 6A of winding type. Generally, manufacturing of the electrode assembly of stack type is easier than manufacturing of the electrode assembly of winding type. Therefore, electrode assembly 6 of stack type can lead to an improvement of production efficiency.

<Shape of Electrode Assembly>

FIG. 3 shows one example of a configuration of electrode assembly 6 in the first embodiment. As shown in FIG. 3, electrode assembly 6 has a flat rectangular parallelepiped outer shape, similarly to battery case 8 (case main body 81). Electrode assembly 6 is housed in battery case 8 such that a longer side (in the figure, a side in a horizontal direction (y direction)) of the flat rectangular parallelepiped shape extends in a longer side direction (see FIG. 2) of battery case 8.

<Positive Electrode>

Positive electrode 1 is a strip-shaped sheet. Positive electrode 1 includes a positive electrode current collector 11 and a positive electrode composite material layer 12. Positive electrode current collector 11 is electrically connected to positive electrode terminal 91 (see FIG. 1). Positive electrode current collector 11 may be, for example, aluminum (Al) foil, Al alloy foil or the like.

In this example, positive electrode composite material layers 12 are formed on both a front surface and a back surface of positive electrode current collector 11. However, positive electrode composite material layer 12 may be formed only on the front surface (any one of the surfaces) of positive electrode current collector 11. Positive electrode composite material layer 12 includes a positive electrode active material, a conductive material, a binder, and a flame retardant (all are not shown).

The positive electrode active material may be, for example, LiCoO₂, LiNiO₂, LiN_{1/3}Co_{1/3}Mn_{1/3}O₂ (NCM), LiNi_{0.8}Co_{0.15}Al_{0.05}O₂ (NCA), LiMnO₂, LiMn₂O₄, or LiFePO₄. Two or more of the positive electrode active materials may be used in combination.

The conductive material may be, for example, acetylene black (AB), furnace black, vapor-deposited carbon fiber (VGCF), or graphite.

The binder may be, for example, polyvinylidene fluoride (PVdF), styrene-butadiene rubber (SBR) or polytetrafluoroethylene (PTFE).

The flame retardant is not particularly limited, as long as it is a flame retardant containing phosphorus (P) or sulfur (S) and a thermal decomposition temperature of the flame retardant is equal to or higher than 80° C. and equal to or lower than 210° C. The flame retardant may be, for example, guanidine sulfamate, guanidine phosphate, guanylurea phosphate, diammonium phosphate, ammonium polyphosphate, ammonium sulfamate, melamine cyanurate, bisphenol A bis(diphenyl phosphate ester), resorcinol bis(diphenyl phosphate ester), triisopyrphenyl phosphate ester, triphenyl phosphate ester, trimethyl phosphate ester, triethyl phosphate ester, tricresyl phosphate ester, tris(chloroisopropyl) phosphate ester, (C₄H₉)₃PO), (HO—C₃H₆)₃PO, a phosphazene compound, diphosphorus pentaoxide, polyphosphoric acid, melamine or the like. One of the flame retardants may be used alone, or two or more of the flame retardants may be used in combination.

<Negative Electrode>

Negative electrode 2 is a strip-shaped sheet. Negative electrode 2 includes a negative electrode composite material layer 22 and a negative electrode current collector 21. Negative electrode current collector 21 is electrically connected to negative electrode terminal 92 (see FIG. 1). Negative electrode current collector 21 may be, for example, copper (Cu) foil.

In this example, negative electrode composite material layers 22 are formed on both a front surface and a back surface of negative electrode current collector 21. However, negative electrode composite material layer 22 may be formed only on the front surface (any one of the surfaces) of negative electrode current collector 21. Negative electrode composite material layer 22 includes a negative electrode active material and a binder (both are not shown).

The negative electrode active material is a graphite-based material. Specifically, the negative electrode active material may be amorphous coated graphite (formed by coating surfaces of graphite particles with amorphous carbon), graphite, soft carbon, or hard carbon.

The binder may be, for example, carboxymethyl cellulose (CMC) or styrene-butadiene rubber (SBR).

<Separator>

Separator 3 is a strip-shaped film. Separator 3 is arranged between positive electrode 1 and negative electrode 2 to achieve electrical insulation between positive electrode 1 and negative electrode 2. A material of separator 3 is a porous material, and may be, for example, polyethylene (PE) or polypropylene (PP).

Separator 3 may have a single layer structure. Separator 3 may be formed only of, for example, a porous film made of polyethylene (PE). In contrast, separator 3 may have a multilayer structure. For example, separator 3 may have a three-layer structure composed of a first porous film made of polypropylene (PP), a porous film made of polyethylene (PE), and a second porous film made of polypropylene (PP).

<Electrolyte>

Electrolyte 7 includes at least a lithium (Li) salt and a solvent. The Li salt is a support electrolyte dissolved in the solvent. The Li salt may be, for example, LiPF₆, UBE′, Li[N(FSO₂)₂], or Li[N(CF₃SO₂)₂]. One of the Li salts may be used alone, or two or more of the Li salts may be used in combination.

The solvent is aprotic. The solvent may be, for example, a mixture of cyclic carbonate and chain carbonate.

The cyclic carbonate may be, for example, ethylene carbonate (EC), propylene carbonate (PC), butylene carbonate (BC), fluoroethylene carbonate (FEC) or the like. One of the cyclic carbonates may be used alone, or two or more of the cyclic carbonates may be used in combination.

The chain carbonate may be, for example, dimethyl carbonate (DMC), ethyl methyl carbonate (EMC), diethyl carbonate (DEC) or the like. One of the chain carbonates may be used alone, or two or more of the chain carbonates may be used in combination.

The solvent may include, for example, lactone, cyclic ether, chain ether, carboxylate ester and the like. The lactone may be, for example, γ-butyrolactone (GBL), δ-valerolactone or the like. The cyclic ether may be, for example, tetrahydrofuran (THF), 1,3-dioxolane, 1,4-dioxane or the like. The chain ether may be, for example, 1,2-dimethoxyethane (DME) or the like. The carboxylate ester may be, for example, methyl formate (MF), methyl acetate (MA), methyl propionate (MP) or the like.

In addition to the Li salt and the solvent, electrolyte 7 may further include various types of functional additives. Examples of the functional additives include a gas generating agent (overcharge additive), an SEI (Solid Electrolyte Interface) film forming agent and the like. The gas generating agent may be, for example, cyclohexylbenzene (CHB) or biphenyl (BP). The SEI film forming agent may be, for example, vinylene carbonate (VC), vinylethylene carbonate (VEC), Li[B(C₂O₄)₂], LiPO₂F₂, propane sultone (PS), or ethylene sulfite (ES).

<Entry of Metal Foreign Object>

It is known that a metal foreign object may enter a battery case in a process of manufacturing a lithium ion secondary battery. A specific example will be described, using cell 5. For example, a metal piece (sputter) may occur when ends of positive electrode current collector 11 and negative electrode current collector 21 are joined by laser welding. A metal piece may also occur when case main body 81 and lid 82 are laser-welded after electrode assembly 6 is housed in case main body 81. Furthermore, in addition to the process of manufacturing cell 5, a metal piece may occur, for example, when an impact is applied to cell 5 due to a collision of a vehicle on which cell 5 is mounted.

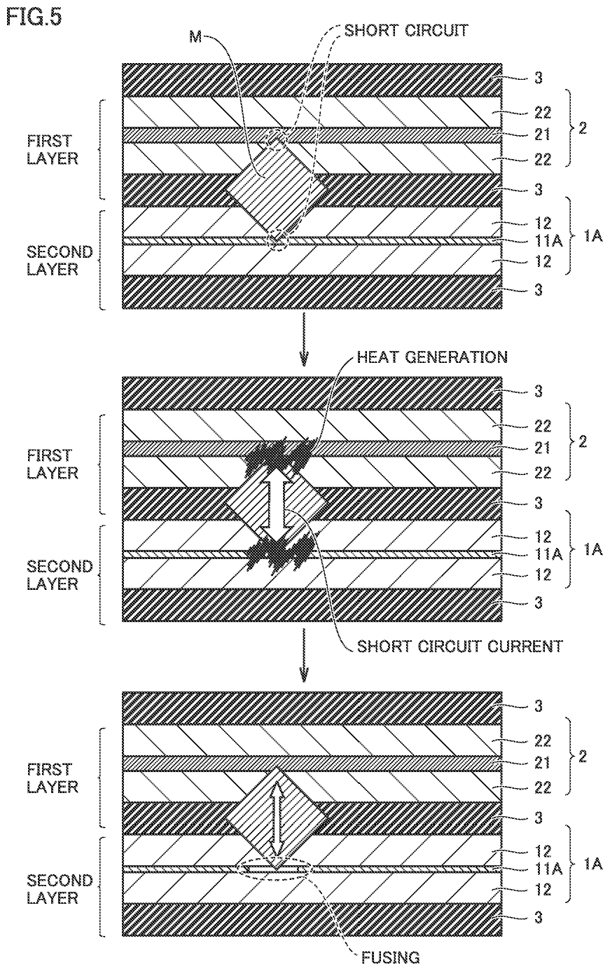

When the metal foreign object enters the battery case, the metal foreign object may adhere to electrode assembly 6, which may cause a short circuit in electrode assembly 6. Then, electrode assembly 6 may generate heat, which may in some cases cause thermal runaway (for further details, see FIG. 5). Therefore, it is conceivable to take measures to suppress the heat generation and particularly the thermal runaway. However, when excessive measures are taken, there may arise an undesirable effect such as a decrease in energy density of cell 5 or an increase in size of cell 5.

The present inventors have focused attention on the fact that when the metal foreign object causes a short circuit in electrode assembly 6, the short circuit is likely to occur in an outermost perimeter portion of electrode assembly 6. In the first embodiment, a thickness of positive electrode current collector 11 of positive electrode 1 arranged at the outermost perimeter of electrode assembly 6 is reduced to intentionally lower a heat resistance of positive electrode current collector 11. As a result, when a short circuit occurs in electrode assembly 6 due to, for example, entry of the metal foreign object, positive electrode current collector 11 is more likely to fuse. When positive electrode current collector 11 fuses, electrical connection (internal short circuit path) between positive electrode current collector 11 and negative electrode current collector 21 through the metal foreign object is cut off, which makes a short circuit current less likely to flow. Therefore, the heat generation in electrode assembly 6 that may lead to the thermal runaway can be suppressed. In addition, the reduction in thickness of positive electrode current collector 11 does not produce an undesirable effect such as an increase in size of cell 5.

<Configuration of Electrode Assembly>

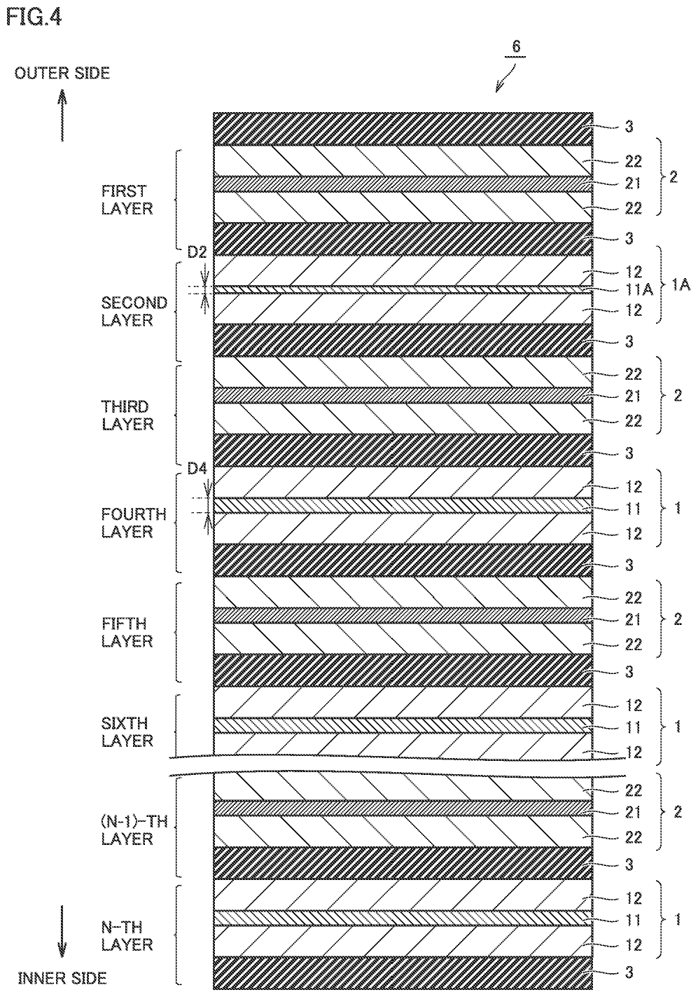

FIG. 4 schematically shows a cross section of electrode assembly 6 taken along line in FIG. 3. FIG. 4 shows a stacked structure of positive electrodes 1, negative electrodes 2 and separators 3 that form electrode assembly 6, from the outer side toward the inner side of electrode assembly 6. The outer side of electrode assembly 6 refers to a side close to battery case 8.

Negative electrode 2 arranged on the outermost side, of the plurality of negative electrodes 2, and separator 3 arranged on the inner side of this negative electrode 2 are denoted as “first layer” (=outermost layer). A layer arranged on the second outermost side, i.e., positive electrode 1 arranged on the inner side of the first layer and separator 3 arranged on the inner side of this positive electrode 1 are denoted as “second layer”. Negative electrode 2 and separator 3 arranged on the third outermost side are denoted as “third layer”. Positive electrode 1 and separator 3 arranged on the fourth outermost side are denoted as “fourth layer”. The same applies as well to fifth and subsequent layers.

Positive electrode current collector 11A of positive electrode 1A arranged in the second layer is thinner than positive electrode current collectors 11 of positive electrodes 1 arranged in the fourth layer and the sixth layer (other even-numbered layers) (D2<D4). Specifically, thickness D2 of positive electrode current collector 11A can be approximately a half of thickness D4 of positive electrode current collector 11. As one example, thickness D4 of positive electrode current collector 11 is 15 μm, while thickness D2 of positive electrode current collector 11A is 8 μm. As described above, in the first embodiment, positive electrode current collector 11A of positive electrode 1A arranged in the second layer is reduced in thickness.

FIG. 5 is a conceptual diagram for illustrating an effect obtained by reducing the thickness of positive electrode current collector 11A. Referring to FIG. 5, a metal foreign object M is highly likely to enter a region in and around the first layer located at the outermost perimeter of electrode assembly 6. FIG. 5 shows a state of an internal short circuit through metal foreign object M between negative electrode current collector 21 of negative electrode 2 arranged in the first layer and positive electrode current collector 11A of positive electrode 1A arranged in the second layer.

When metal foreign object M causes an internal short circuit, a short circuit current flows from entire electrode assembly 6 toward the internal short circuit portion, which causes the short circuit portion to generate heat locally and have a high temperature. Then, an exothermic reaction (such as a decomposition reaction and an oxidation reaction) of the electrode material occurs in the short circuit portion, which causes the short circuit portion to further generate heat. The heat generation occurs successively, which may cause thermal runaway in electrode assembly 6.

In the present embodiment, thickness D2 of positive electrode current collector 11A is small and is approximately a half of thickness D4 of positive electrode current collector 11. Therefore, positive electrode current collector 11A fuses in a short time due to heat generation caused by propagation of the short circuit current. Specifically, when the thickness of positive electrode current collector 11A is 8 μm as described above, the fusing time can be reduced in approximately half, as compared with when the thickness of the positive electrode current collector is 15 μm. When positive electrode current collector 11A fuses, an electrical resistance of the internal short circuit path increases, which makes the short circuit current less likely to flow (ideally, causes no short circuit current to flow). As a result, an amount of heat generation by the short circuit current in the short circuit portion decreases, which makes the exothermic reaction of the electrode material less likely to occur in the short circuit portion. Therefore, thermal runaway in electrode assembly 6 can be suppressed.

FIGS. 4 and 5 illustrate the example in which positive electrode current collector 11A reduced in thickness is provided only in the second layer (layer in which the outermost positive electrode, of the plurality of positive electrodes 1, is located). Positive electrode current collector 11A reduced in thickness corresponds to “fusing member” according to the present disclosure. The second layer corresponds to “outer layer” according to the present disclosure, and the third layer or a layer (or layers) arranged on the inner side of the third layer corresponds to “inner layer”.

However, positive electrode current collector 11A reduced in thickness may be provided at least in positive electrode 1A arranged on the outermost side of electrode assembly 6, or may be provided over several layers from the outer side of electrode assembly 6. Positive electrode current collectors 11A may be provided in, for example, the second layer and the fourth layer. In this case, the second layer and the fourth layer correspond to “outer layer” according to the present disclosure, and the fifth layer or a layer (or layers) arranged on the inner side of the fifth layer corresponds to “inner layer”. Alternatively, positive electrode current collectors 11A may be provided in, for example, the second layer, the fourth layer and the sixth layer. In this case, the second layer, the fourth layer and the sixth layer correspond to “outer layer” according to the present disclosure, and the seventh layer or a layer (or layers) arranged on the inner side of the seventh layer corresponds to “inner layer”. However, it is not preferable that positive electrode current collector 11A reduced in thickness are provided in all of the even-numbered layers.

As described above, in the first embodiment, positive electrode current collector 11A of positive electrode 1A arranged on the outermost side, of the plurality of stacked positive electrodes 1, is made thinner than positive electrode current collector 11 of positive electrode 1 arranged on the inner side of electrode assembly 6. As a result, when electrode assembly 6 is short-circuited due to entry of metal foreign object M, positive electrode current collector 11A can be immediately fused using heat generation caused by the short circuit current, and the remaining portion of positive electrode current collector 11A can be electrically separated from the short circuit counterpart (negative electrode current collector 21). Therefore, according to the first embodiment, it is possible to suppress thermal runaway in electrode assembly 6 even when electrode assembly 6 is short-circuited, while preventing an undesirable effect such as a decrease in energy density or an increase in size.

### Second Embodiment

Fusing of the positive electrode current collector can also be promoted by a method other than the reduction in thickness of the positive electrode current collector. In a second embodiment, description will be given of an example in which through holes are provided in a positive electrode current collector to make the positive electrode current collector thermally vulnerable. An overall configuration of a lithium ion secondary battery (cell) according to the second embodiment is similar to the configuration shown in FIGS. 1 and 2, and thus, detailed description will not be repeated.

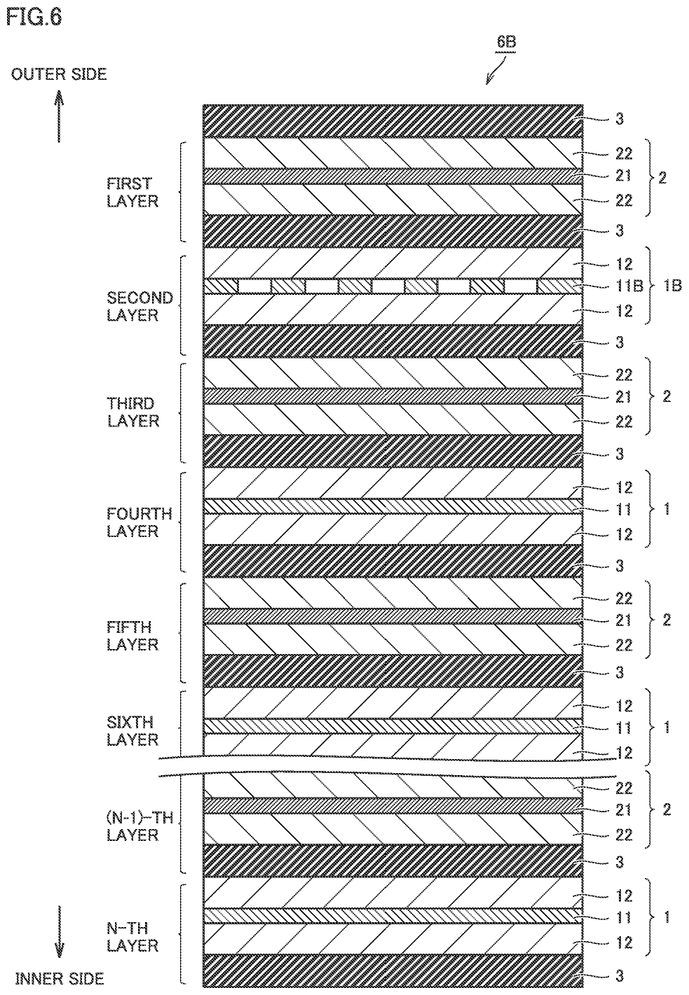

FIG. 6 schematically shows a cross section of an electrode assembly in the second embodiment. Referring to FIG. 6, a positive electrode 1B arranged in a second layer of an electrode assembly 6B is different from positive electrodes 1 arranged in the other even-numbered layers such as the fourth layer, in that positive electrode 1B includes a positive electrode current collector 11B instead of positive electrode current collector 11.

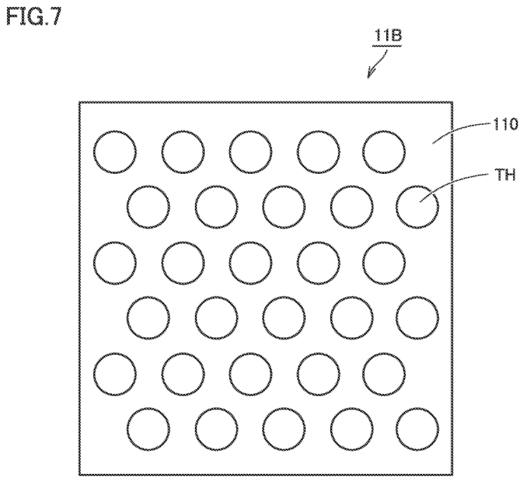

FIG. 7 is a top view showing a structure of positive electrode current collector 11B in the second embodiment. Referring to FIG. 7, positive electrode current collector 11B is a punching metal formed by punching a base material 110 (such as aluminum foil) of positive electrode current collector 11. A ratio of through holes TH aligned in base material 110 to a total area of positive electrode current collector 11B may be set as appropriate in accordance with a thickness of positive electrode current collector 11B and the like, and the ratio is, for example, 50%.

A volume of base material 110 of positive electrode current collector 11B is smaller, by a volume of through holes TH, than a volume of a base material of positive electrode current collector 11 having no through holes TH. Therefore, a heat capacity of positive electrode current collector 11B is smaller than a heat capacity of positive electrode current collector 11. Thus, similarly to the first embodiment (see FIG. 5), positive electrode current collector 11B fuses in a short time due to heat generation caused by propagation of a short circuit current in the second embodiment. For example, when the ratio of through holes TH is set at 50%, the fusing time can be reduced in approximately half, as compared with when through holes TH are not provided. When positive electrode current collector 11B fuses, an electrical resistance between negative electrode current collector 21 of negative electrode 2 and positive electrode current collector 11B of positive electrode 1B increases, which makes the short circuit current less likely to flow. As a result, an amount of heat generation caused by the short circuit current in the short circuit portion decreases, which makes an exothermic reaction of the electrode material less likely to occur in the short circuit portion. Therefore, thermal runaway in electrode assembly 6B can be suppressed.

Positive electrode current collector 11B is not limited to the punching metal, as long as it is flat plate-shaped metal foil provided with a plurality of through holes TH. Positive electrode current collector 11B may be an expanded metal, a lath metal or the like.

As described above, in the second embodiment, positive electrode current collector 11B of positive electrode 1B arranged on the outermost side of electrode assembly 6B is provided with the plurality of through holes TH. Thus, when electrode assembly 6B is short-circuited due to entry of metal foreign object M, positive electrode current collector 11B can be immediately fused using heat generation caused by the short circuit current, and the remaining portion of positive electrode current collector 11B can be electrically separated from the short circuit counterpart (negative electrode current collector 21). Therefore, according to the second embodiment, it is possible to suppress thermal runaway in electrode assembly 6B even when electrode assembly 6B is short-circuited, while preventing an undesirable effect such as a decrease in energy density or an increase in size.

While the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A non-aqueous electrolyte secondary battery comprising:
an electrode assembly including a plurality of sheet-shaped positive electrodes and a plurality of sheet-shaped negative electrodes, the plurality of positive electrodes and the plurality of negative electrodes being alternately stacked with separators interposed therebetween; and
a battery case that houses the electrode assembly, wherein
the electrode assembly includes:
an outer layer including a positive electrode arranged on an outermost side of the electrode assembly, of the plurality of positive electrodes, and a separator adjacent to the positive electrode, of the separators; and
an inner layer arranged on an inner side of the outer layer,
the outer layer includes a fusing member configured to fuse due to heat generation in the electrode assembly caused by a short circuit in the electrode assembly, and
the inner layer does not include the fusing member.

2. The non-aqueous electrolyte secondary battery according to claim 1, wherein
each of the plurality of positive electrodes includes a positive electrode current collector and a positive electrode composite material layer,
the positive electrode current collector arranged in the outer layer is thinner than the positive electrode current collector arranged in the inner layer, and
the fusing member includes the positive electrode current collector arranged in the outer layer.

3. The non-aqueous electrolyte secondary battery according to claim 1, wherein
each of the plurality of positive electrodes includes a positive electrode current collector and a positive electrode composite material layer,
the positive electrode current collector arranged in the outer layer is perforated metal foil provided with a plurality of through holes, and
the fusing member includes the perforated metal foil.

4. The non-aqueous electrolyte secondary battery according to claim 3, wherein
the perforated metal foil is any one of a punching metal, an expanded metal and a lath metal.

5. The non-aqueous electrolyte secondary battery according to claim 1, wherein
the electrode assembly is of stack type.
